(19) United States
(12) Patent Application Publication
(10) Pub. No.: US 2007/0142979 A1
(43) Pub. Date: Jun. 21, 2007

(54) Method for the selection of a participant in a medical project with selection criteria for patients

(76) Inventors: Klaus Abraham-Fuchs, Erlangen (DE); Eva Rumpel, Erlangen (DE); Markus Schmidt, Nuremberg (DE); Siegfried Schmeider, Erlangen (DE); Horst Schreiner, Furth (DE); Gudrun Zahlmann, Neumarkt (DE)

Correspondence Address: HARNESS, DICKEY & PIERCE, P.L.C., P.O.BOX 8910, RESTON, VA, 20195, US

(21) Appl. No.: 10/589,539

(22) PCT Filed: Feb. 8, 2005
(86) PCT No.: PCT/EP05/50551

§ 371 Date: Aug. 16, 2006

(30) Foreign Application Priority Data
Feb. 18, 2004 (DE) 10 2004 008 188.3
Oct. 28, 2004 (DE) 10 2004 052 468.8

(51) Int. Cl. G06Q 10/00

(52) U.S. Cl. 701/3; 705/2

(57) ABSTRACT

A method is disclosed for selecting a participant in a medical project with selection criteria for patients. The method includes verifying patient data, that is contained in a data processing system and is associated with patients, regarding the selection criteria. The patient associated with the patient data is selected as a participant if the selection criteria are met. Finally, the patient is reported as a participant

### PRIORITY STATEMENT

This application is the national phase under 35 U.S.C. § 371 of PCT International Application No. PCT/EP2005/050551 which has an International filing date of Feb. 8, 2005 which designated the United States of America and which claims priority on German Patent Application numbers DE 10 2004 008 188.3 filed Feb. 18, 2004 and DE 10 2004 052 468.8 filed Oct. 28, 2004, the entire contents of which are hereby incorporated herein by reference.

### FIELD

The invention generally relates to a method for selecting a participant for a medical project with selection criteria for patients.

### BACKGROUND

Medical projects are set up by various backers and sponsors for the purpose of testing, on patients, new medicaments, treatment methods, examination methods, medical procedures, guidelines for everyday hospital practice, or comprehensive treatment and care concepts, such as in disease management. Examples of such projects can be internal outcome analyses, investigations or research projects, or clinical studies.

For patients taking part in a project of this kind, selection criteria are set down before the start of the project, and in most cases. After the project has started, these selection criteria can no longer be modified, or they can be modified only to a very minor extent. In the case of clinical studies, these selection criteria involve very detailed inclusion and exclusion criteria according to which patients are selected as study participants only if they comply with a strictly defined patient type. The narrower the selection criteria are formulated, the more difficult it is, in the course of the project, to find patients who meet the selection criteria and who are entered as participants in the study.

Suitable patients are difficult to find particularly in cases where the selection criteria state that a patient is suitable for the relevant project only within a short time interval after a diagnosis has been made or a therapeutic step has been taken. The reason for this is that, for example in a given patient situation, the medicaments, diagnostic methods or treatment methods that are to be tested in the context of the project have to be administered or initiated before what is generally the standard first line of treatment of the patient.

The selection of suitable participants for a medical project has hitherto been carried out by a person responsible for this, for example by a physician who is informed about the medical project and the corresponding selection criteria and who comes across suitable patients in his everyday practice. A small crib carried around in the physician's pocket often serves as a memory aid.

In this way, many patients suitable as participants are not recognized as such, because a treating physician is not informed of the project, or because a physician who has been informed of it does not routinely think about the project in his daily practice, does not correctly appreciate the selection criteria, or is overworked, overtired or inattentive.

### SUMMARY

At least one embodiment of the present invention includes improving the selection of a participant for a medical project with selection criteria for patients.

A method, in at least one embodiment, is for selecting a participant for a medical project with selection criteria for patients. The method includes checking patient data contained in a data processing system and associated with patients, with respect of the selection criteria. The patient associated with the patient data is selected as a potential participant if the selection criteria are met. The patient is reported as a potential participant.

Many different types of data processing systems are used in routine medical practice. These can be, for example, systems for administering a general practice, hospital administration systems, physicians' desktop computers, or apparatuses for storing and processing data in the ward or in the laboratory area (such as measurement apparatus or diagnostic apparatus in an intensive care ward or in a laboratory, for example). All these apparatus determine, record or process a large amount of data associated with patients. These data are, for example, the age, weight, blood pressure, pulse or blood counts of a specific patient.

These patient data are checked in respect of the selection criteria for a medical project. This determines whether a patient meets the selection criteria for the project. A check in the data processing system is seamless, cannot be forgotten, and is able to be carried out rapidly and close to real time. None of the selection criteria can be overlooked.

The selection is objective and does not depend on the stress, workload or state of fatigue of a person carrying out the selection. Since the patient data are related to an individual person, a conclusion can easily be drawn from the patient data back to the patient. In this way, a patient whose patient data meet the selection criteria is reliably and quickly selected as a potential participant.

“Potential” participant signifies that while the patient meets the selection criteria and is thus considered as a participant, it does not mean that he actually participates in the medical project. For this, further conditions may have to be met, as are described below. If no further conditions are to be met, the potential participant is immediately also an actual participant.

If the patient is selected as a potential participant, this is reported for example directly to the patient or to the person responsible for him, but preferably first to the data processing system which relays or further processes this information in a suitable manner. In this way, the patient or medical personnel are immediately informed of the patient's selection as a potential participant in the project.

The selection of a potential participant is done by electronic comparison, and it can therefore be carried out in any location, in a reliable manner and close to real time. The medical personnel are relieved of the task of selecting a potential participant and are informed only in the case where the patient meets the selection criteria. The technical implementation of the check of the selection criteria in the data processing system can be done, for example, by an external knowledge-based test system linked to the data processing system, by software agents or database triggers and stored procedures in the data processing system.

The check in respect of the selection criteria can take place automatically when the patient data in the data processing system change. Such a change occurs, for example, as a result of a diagnostic or therapeutic step which is carried out on the patient and whose results or implementation are entered in the data processing system. If the patient whose patient data have been changed, or are changing, meets the selection criteria after the change and is selected as a potential participant, the time for recognizing the patient as a potential participant depends only on when the patient data in the data processing system are changed, and the time for the automatic check of the modified data can in most cases be ignored.

If the data processing system is, for example, a measurement computer which is permanently linked up to the patient, for example an automatic blood pressure monitor, a change in the data is detected practically without time delay. The check of the selection criteria thus takes place as close as possible to real time and by purely electronic means. The selection of a potential participant is in this way made considerably quicker. Therefore, for each change in the characteristics of a patient which are characterized by the patient data, a check is carried out on whether the patient now meets the selection criteria of a project.

If an agreement on the part of the potential participant is needed for conducting the medical project, this can be requested of the potential participant, that is to say the patient. Further actions can also be initiated. Depending on the time frame available for the project, the patient can be informed in writing or can be spoken to directly. A physician responsible for the project or a physician treating the patient can be informed as quickly as possible, for example by phone, via text message or a pager. Only when the patient has agreed, is he selected as a participant and reported as such.

The selection of a patient as a potential participant can take place during a treatment of the patient that is correlated with the medical project. The request concerning participation is then generated during the treatment and transmitted to the patient. If the patient agrees, the treatment is continued on him as a participant in accordance with the medical project.

Situations like this arise when for example, in the context of the medical project, time-critical treatment or diagnostic steps are necessary on the patient, or when the latter must under no circumstances receive any conventional treatment since this would make the conduct of the medical project impossible.

Since the request is made to the patient immediately, that is to say during the treatment correlated with the medical project, for example a standard procedure for a specific diagnosis that cannot be combined with the medical project, the standard procedure can, if agreed, be immediately interrupted, and the new trial treatment according to the medical project can be pursued without delay and thus without disadvantage for patient and project.

If rules of conduct are assigned to the medical project, this means that when a patient is selected as participant, these rules of conduct can be reported to a suitable recipient, preferably once again to the data processing system. The data processing system and, therefore, the responsible persons are therefore not only informed that a participant has been found or selected, but are also supplied with additional information, for example about what is now to be done with or to the participant, which regulations or process steps are to be initiated, or, generally, which workflow is to be observed in the medical project. The fact that these rules of conduct can be sent from the data processing system to responsible persons or to the patient as far as possible without delay ensures that they are observed to the best possible extent.

If the rules of conduct are assigned to the potential participant, that is to say the patient, a treating physician whose patient is suitable at a certain point in time as a participant for a project does not have to ask to be informed about the project, but instead immediately receives the specific and required information on how to proceed. This also makes matters easier for the medical personnel. The time needed to familiarize the medical personnel with the medical projects is reduced and an effective and speedy process ensured.

A correct procedure according to the rules is guaranteed in particular when the rules of conduct are transmitted to a workflow management system which controls and monitors the further course of the medical project. This also includes automatic time and resource planning of personnel, laboratories and laboratory time, room occupancy, duty rosters, etc.

If the project is a clinical study, additional advantages are achieved since, at the time its starts, a great deal of time and money has usually already been invested, and its success mainly depends on finding a sufficient number of study participants. This is greatly improved by the method according to at least one embodiment of the invention, leading to savings in terms of money and time for the backer or sponsor of the clinical study.

### BRIEF DESCRIPTION OF THE DRAWINGS

The invention is described in more detail on the basis of an illustrative embodiment and with reference to the schematic drawing, in which:

FIG. 1 shows the conduct of a method for selecting a participant for a clinical study with inclusion/exclusion criteria for patients.

### DETAILED DESCRIPTION OF THE EXAMPLE EMBODIMENTS

In the following example, at least one embodiment of the invention is described on the basis of a clinical study, since generally standardized terms and formulations are widely known for clinical studies. However, the example can also be applied to other medical projects.

In a clinical study, a new medicament is tested which is intended to control acute inflammations in patients. An important aspect here is that the medicament has to be administered to the patient as a first treatment after the appearance of the inflammation, i.e. no generally customary treatment of the inflammation is conducted before the administration of the new medicament. The selection criteria for study participants are therefore—Inclusion criterion: the existence of an inflammation; Exclusion criterion: The patient has already been receiving treatment for the inflammation.

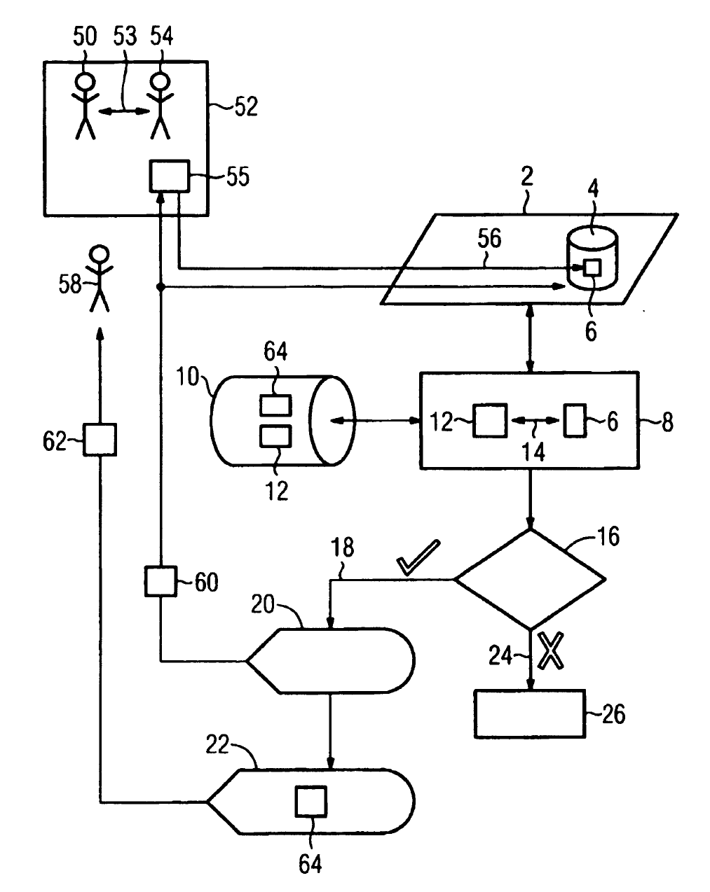

The sequence for selecting a patient 50 as a participant for the clinical study is shown in FIG. 1. The patient 50, who has a severe inflammation, is admitted to an emergency department 52 of a hospital. He is examined, as indicated by arrow 53, by an emergency physician 54 who confirms the inflammation.

In an initial step 2, using a data terminal 55, the emergency physician 54 enters the diagnosis “Inflammation” together with the personal details of the patient 50 as patient data 6 into a database 4 of a data processing system in the hospital, this operation being indicated by the arrow 56. Since the hospital in question is taking part in the above-mentioned clinical study, the study sponsor has set up the database 4 with a database trigger which, for all keywords associated with inflammations, instigates a check of the data set in which they occur.

Since a new entry corresponds to a change of the patient data 6, a verification step 8 is therefore executed. The inclusion/exclusion criteria 12 of the clinical study are read out from a study database 10 which contains all the information connected with the clinical study, and the patient data 6 are checked in respect of the inclusion/exclusion criteria 12, as is represented by the arrow 14.

In the decision step 16, it is established that the patient data 6 meet the inclusion/exclusion criteria 12 of the study.

Therefore, a YES decision 18 is taken in decision step 16. This leads to a report step 20 in which a report 60 is transmitted to the emergency physician 54 and to the database 4. The report states that the patient 50 associated with the patient data 6 is suitable as a potential participant for the clinical study. The report 60 is output together with a warning bleep on the data terminal 55 in the emergency department 52 where the emergency physician 54 has entered the patient data 6.

By way of the report to the administering system in the form of the database 4, various actions are triggered simultaneously in the hospital workflow: The schedules of physicians on duty are checked, and a study physician 58 who is responsible for the study is determined. Times are booked for expected laboratory work. A decision is made on whether the patient 50 is in fact to be administered the new active substance or a placebo.

Verification step 8 and decision step 16 are carried out practically directly after the data has been input by the emergency physician 54. Therefore, the emergency physician 54 has not yet begun an inflammation treatment customary for the symptoms with which the patient 50 has been diagnosed, but is instead still making preparations for this treatment.

By way of the report 60 to the data terminal 55, however, the emergency physician 54 is informed of the clinical study and in the first instance does not treat the patient 50, but instead informs the patient of the clinical study according to the report 60 that has been sent. He learns from the report 60 that a person responsible for the study will take over the patient 50 from him.

In a further report step 22, a study physician 58 responsible for the clinical study in the hospital is sent a further report 62 in the form of a message on his pager and in the form of a fax in his office. The study physician 58 is informed of all the steps that have to be taken on the patient 50 that are prescribed in the rules of conduct 64 of the clinical study. The rules of conduct 64 are stored in the study database 10.

From the report 62, the study physician 58 learns that he will find the patient 50 in the emergency department 52, is to take over the patient from the emergency physician 54 there, and first has to obtain the consent of the patient 50 to participate in the clinical study. He then has to administer the new active substance to the patient. As a memory aid, the report 62 also informs him of how he is to monitor the course of the inflammation in the subsequent period according to the rules of conduct 64.

In a second example which is likewise explained with reference to FIG. 1, and whose sequence is largely the same as in the above description, a second patient 50 is admitted to the emergency department 52 of the hospital and, after an examination (arrow 53), his patient data 6 are entered into the database 4 by the emergency physician 54. Because of a chronic inflammation, the patient 50 has already been being treated by a general physician (not shown) and is consulting the emergency department 52 because of an acute deterioration of his symptoms.

In verification step 8, the patient data of the patient 50 are checked for the inclusion/exclusion criteria 12, and it is established that the inflammation of patient 50 has already been treated by the general physician. The exclusion criterion 12 is therefore met, and the patient 50 is not suitable for participation in the study.

Therefore, in decision step 16, the NO decision 24 is made, for which reason, in the final step 26, the patient 50 associated with the patient data 6 is rejected as a participant for the study, and no further action is taken. For this patient 50, the emergency physician 54 therefore continues as usual with the normal treatment of the inflammation.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for selecting and reporting a potential participant for a medical project with selection criteria for patients, said method comprising:
checking patient data, contained in a data processing system and associated with patients, with respect to the selection criteria;
selecting the patient associated with the patient data as a potential participant if the selection criteria are met; and
reporting the selected patient as a potential participant.

2. The method as claimed in claim 1, wherein
verification, with respect to the selection criteria, takes place automatically when the patient data in the data processing system change.

3. The method as claimed in claim 1, wherein, in order to conduct the medical project, an agreement of the participant is needed in which
when a patient is selected as a potential participant, the data processing system automatically generates a request asking for the participant's agreement,
the request is transmitted to the patient, and
in the event of an agreement, the patient is selected as a participant and reported.

4. The method as claimed in claim 3, wherein the selection of a patient as a potential participant takes place during a treatment of the patient which is correlated with the medical project, wherein
the request is generated during the treatment and transmitted to the patient, and
if the patient agrees, the treatment is continued on him as a participant in accordance with the medical project.

5. The method as claimed in claim 1, wherein
rules of conduct are assigned to the medical project, and
when a patient is selected as a potential participant, the rules of conduct are reported.

6. The method as claimed in claim 5, wherein
when a patient is selected as a potential participant, the rules of conduct are assigned to the selected patient.

7. The method as claimed in claim 5, wherein
the rules of conduct are transmitted to a workflow management system.

8. The method as claimed in claim 1, wherein
a clinical study is conducted as the medical project.

9. The method as claimed in claim 2, wherein, in order to conduct the medical project, an agreement of the participant is needed in which
when a patient is selected as a potential participant, the data processing system automatically generates a request asking for the participant's agreement,
the request is transmitted to the patient, and
in the event of an agreement, the patient is selected as a participant and reported.

10. The method as claimed in claim 9, wherein the selection of a patient as a potential participant takes place during a treatment of the patient which is correlated with the medical project, where
the request is generated during the treatment and transmitted to the patient, and
if the patient agrees, the treatment is continued on him as a participant in accordance with the medical project.

11. The method as claimed in claim 2, wherein
rules of conduct are assigned to the medical project, and
when a patient is selected as a potential participant, the rules of conduct are reported.

12. The method as claimed in claim 11, wherein
when a patient is selected as a potential participant, the rules of conduct are assigned to the selected patient.

13. The method as claimed in claim 6, wherein
the rules of conduct are transmitted to a workflow management system.

14. The method as claimed in claim 2, wherein
a clinical study is conducted as the medical project.
